(19) United States
(12) Patent Application Publication
(10) Pub. No.: US 2011/0308365 A1
(43) Pub. Date: Dec. 22, 2011

(54) SAFETY DEVICE FOR MACHINE TOOL

(75) Inventors: CHIH-HUI CHIU, YILAN COUNTY (TW); JUN-DA WU, TAOYUAN COUNTY (TW); BO-JYUN SIAO, TAOYUAN COUNTY (TW)

(73) Assignee: YUAN ZE UNIVERSITY, TAOYUAN (TW)

(21) Appl. No.: 13/224,576

(22) Filed: Sep. 2, 2011

Related U.S. Application Data
(63) Continuation-in-part of application No. 12/108,532, filed on Apr. 24, 2008.

(51) Int. Cl. B26D 7/24

(52) U.S. Cl. 83/62.1

(57) ABSTRACT

A safety device for a machine tool includes a machine, a main controller, a detection unit, a warning system, a drive circuit and a temporary stop device. The detection unit includes a contact sensing element and a non-contact sensing element. After the detection unit is induced and triggered by a charged body, a sensing signal is generated and transmitted to the main controller and interpreted by the main controller to drive the warning system, and the drive circuit transmits an analog signal to a charged body of the temporary stop device to rotate a motor of the machine in a reverse direction for a brake. The present invention provides a double sensing protection device with both contact and non-contact sensing effects to improve the safety of using the machine tool and prevent operators from being injured.

### CROSS-REFERENCE TO RELATED APPLICATIONS

This application is a continuation-in-part patent application of U.S. application Ser. No. 12/108,532 filed on Apr. 24, 2008, currently pending, the entire contents of which are hereby incorporated by reference for which priority is claimed under 35 U.S.C. §120.

### FIELD OF THE INVENTION

The present invention relates to a safety device, in particular to the safety device for a cutting machine tool.

### BACKGROUND OF THE INVENTION

Although the cutting machine tool can cut materials and manufacture appliances or semi-finished goods, extreme cautions must be taken in its use to prevent injuries or even deaths caused by negligence or wrong operations.

Among various cutting machine tools, a sawing machine is one of the commonest machine tools that cuts and injures users or operators during its operation, particularly the wood sawing machine. Regardless of professional technicians or people accustomed to DIY, the number of users or operators injured by the sawing machine is countless. To improve the safety of using the sawing machine, a safety protection device is generally installed to the sawing machine.

With reference to FIG. 6 for a flow chart of a protection procedure of a safety protection device as disclosed in U.S. Pat. No. 7,055,417, electric charges are inputted to a saw blade after a sawing machine is turned on. Since human body is a charged body, so that once if the human body touches the saw blade, the electric charges of the saw blade will be discharged (referring to steps S11˜S14). Different braking systems (such as those with a retraction of a circular blade or an embedded brake) will be turned on immediately to achieve a braking effect and a safety protection.

The aforementioned patented invention still has the following drawbacks:

(1) When the protection system is turned on, it is necessary to introduce the electric charges to the saw blade, and the procedure is relatively complicated and troublesome.

(2) When the protection system is braked or shut down, the embedded braking method is mainly used, and the whole set of the saw blade will be damaged. In other words, a replacement of the saw blade is required for each shutdown, thus incurring a high cost.

(3) The protection device is turned on only if the charged body is in contact with a human body or a charged object, and the user may still be injured.

### SUMMARY OF THE INVENTION

Therefore, it is a primary objective of the present invention to provide a safety protection device with a contact or non-contact sensing method of a charged body for the saw blade, so as to increase the response time and accelerate the protection action for users or operators and reduce the chance of the users or operators getting injured.

To achieve the aforementioned objective, the present invention provides a safety device for a machine tool, comprising: a machine, having a saw blade installed thereon and driven by a motor to rotate; a main controller, for determining an induced trigger status to generate an analog signal; a detection unit, electrically coupled to the main controller, and comprising: a contact sensing element, being an electrostatic charge sensor, and using a grounding line, and a Darlington trigger method to sense a signal of a charged body, and setting a threshold of the electrostatic charge sensor as a reference value, and creating an induced trigger when an electric charge is different from the reference value; and a non-contact sensing element, being a capacitance sensor, and forming an induced space magnetic field, and forming an induced trigger when the charged body approaches the induced space magnetic field, and after the detection unit is induced and triggered, a sensing signal is transmitted to and interpreted by the main controller; a warning system, electrically coupled to the main controller, for turning on the warning system after the analog signal is received; a drive circuit, electrically coupled to the main controller, for transmitting the analog signal to drive a brake; and a temporary stop device, electrically coupled to the drive circuit, for rotating the motor in a reverse direction immediately after the analog signal is received.

Wherein, the warning system includes a warning light and an alarm.

Wherein, the electrostatic charge sensor is installed at the axis of the saw blade, such that the saw blade becomes a sensing component, and the capacitance sensor is installed at a position in front of the saw blade.

Another objective of the present invention is to provide an operating method of the aforementioned safety device for a machine tool to effectively reduce the chance of having a wrong operation.

To achieve the foregoing objective, the operating method comprises the steps: resetting the detection unit to discharge electrostatic charges of the electrostatic charge sensor, setting a threshold of the detection unit as a reference value, and resetting the capacitance of the capacitance sensor; determining an induced trigger status by the main controller; turning on the temporary stop device to brake the motor in a reverse direction after a trigger is induced; turning on the warning system to produce warning sound and light simultaneously; discharging the electrostatic charges of the electrostatic charge sensor, setting the threshold to a reference value, and resetting the capacitance of the capacitance sensor after a troubleshooting is completed; and determining whether or not the resetting process is completed by the main controller; simultaneously cancelling the warning system to turn off both warning sound and light; and releasing the temporary stop device to resume the operation of the motor.

Wherein, the steps of discharging the electrostatic charge of a first sensor and resetting the capacitance of the second sensor include a delay time provided for the main controller to determine whether or not the procedure is completed.

Another objective of the present invention is to integrate the aforementioned non-contact sensing unit (which is an electrostatic charge sensor) and a contact sensing unit (which is a capacitance sensor) into a detection unit, and use a program to compute a specific value of the sensing signals after a human body is induced and triggered by the non-contact sensing unit and the contact sensing unit to assist the main controller to interpret and transmit the analog signal to turn on the temporary stop device, such that the analog signal can be transmitted more accurately.

### BRIEF DESCRIPTION OF THE DRAWINGS

FIG. 1 is a hardware block diagram of the present invention;

FIG. 2 is a schematic view of an installed assembly of the present invention;

FIG. 3 is a first schematic view of an operation of the present invention;

FIG. 4 is a second schematic view of an operation of the present invention;

FIG. 5 is a schematic view of triggering a sensor installed to a machine according to the present invention; and

FIG. 6 is a flow chart of a prior art.

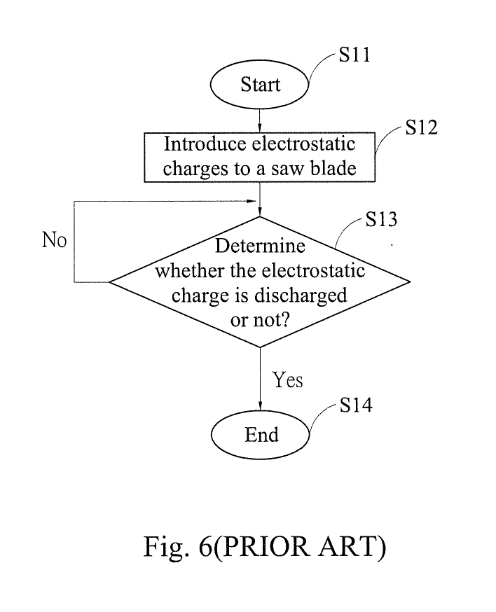

### DESCRIPTION OF THE PREFERRED EMBODIMENTS

The technical characteristics and effects of the present invention will become apparent by the detailed description of preferred embodiments and related drawings as follows.

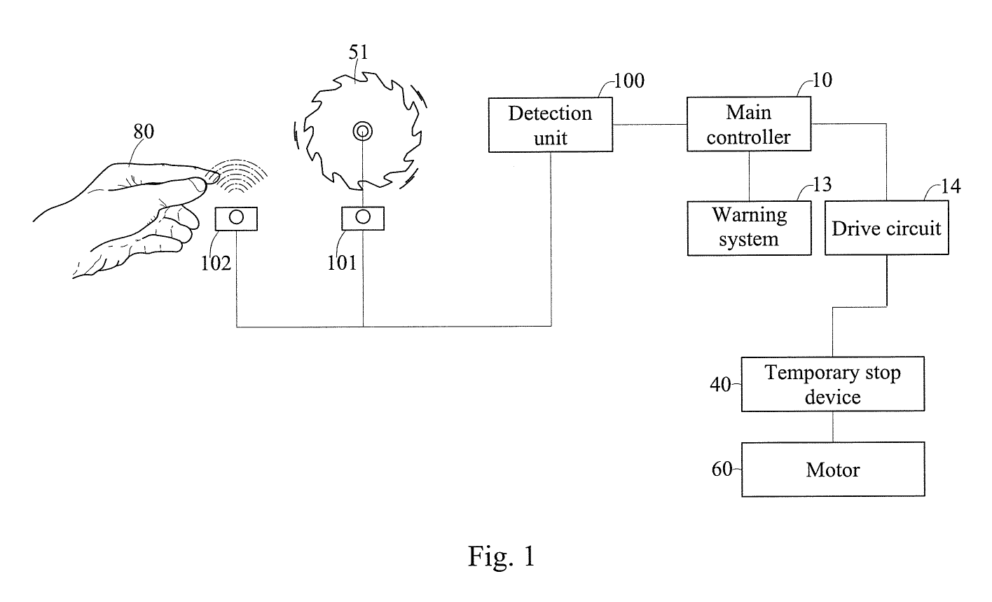

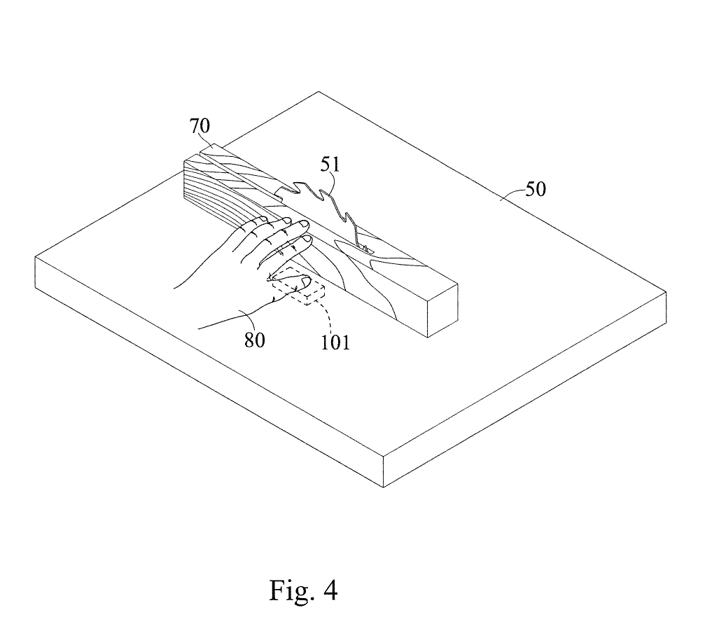

With reference to FIGS. 1 to 4 for a safety device for a machine tool in accordance with the present invention, the safety device comprises a machine 50, a main controller 10, a detection unit 100, a warning system 13, a drive circuit 14 and a temporary stop device 40.

The machine 50 includes a saw blade 51 installed thereon and driven by a motor 60 to rotate.

The main controller 10 is provided for determining an induced trigger status to generate an analog signal.

The detection unit 100 is electrically coupled to the main controller 10, and comprises the following elements:

A contact sensing element 101 is an electrostatic charge sensor installed at an axis of the saw blade 51, such that the saw blade 51 becomes a sensing component, for using a grounding line and a Darlington trigger method to sense a signal of the charged body, and set the threshold of the electrostatic charge sensor as a reference value (varied with different materials). If the electric charge is different from the reference value (such as in the situation when a human body with electrostatic charges is touched), an induced trigger is produced.

A non-contact sensing element 102 is a capacitance sensor installed at a position in front of the saw blade 51 to form an induced space magnetic field. When the charged body approaches the induced space magnetic field, an induced trigger is produced. After the detection unit 100 is sensed and induced, a sensing signal is outputted to and interpreted by the main controller 10.

The warning system 13 is electrically coupled to the main controller 10, and the warning system 13 is turned on after the control signal is received, and the warning system includes a warning light (LED) and an alarm.

The drive circuit 14 is electrically coupled to the main controller 10 for transmitting the analog signal for driving or braking the machine tool.

The temporary stop device 40 is electrically coupled to the drive circuit 14 for rotating the motor 60 in a reverse direction to brake the machine tool immediately after the analog signal is received.

In addition, the charged body integrates the aforementioned non-contact sensing unit 102 and contact sensing unit 101 into a detection unit 100, and a program is used for computing a specific value of sensing signals generated by the non-contact sensing unit 102 and the contact sensing unit 101, when a human body is induced and triggered, so as to assist the main controller 10 to determine and output an analog signal to transmit the analog signal more accurately.

When the present invention is used, a non-charged body of wood 70 is pushed towards a machine 50, no trigger is induced by the non-contact sensing element 102 in the induced space magnetic field, since the wood does not carry any electrostatic charge, and thus the machine 50 continues its normal operation. When the wood 70 is contacted with the saw blade 51, the contact sensing element 101 will not be induced or triggered, so that the motor 60 can continue its normal operation without being shut down by false alarm. If a charged body such as an operator's finger 80 enters into the induced space magnetic field of the non-contact sensing element 102, a trigger is induced, and the non-contact sensing unit 102 will generate a signal to the main controller 10 to turn on the temporary stop device 40, and rotate the motor 60 in a reverse direction. If the non-contact sensing element 102 is not operated, or the charged body is not passed through the induced space magnetic field of the non-contact sensing element 102, the motor 60 continues its normal operation. If there is still a chance for the operator's finger 80 to touch the saw blade 51, the contact sensing element 101 will perform an induced trigger of the charged body, and the non-contact sensing element 102 and the contact sensing element 101 will transmit the sensing signal to notice the main controller 10 to turn on the temporary stop device 40 in order to reversely rotate and stop the saw blade 51. In the meantime, the warning system 13 is turned on to produce warning sound or light to notice people nearby to provide assistance or take proper actions.

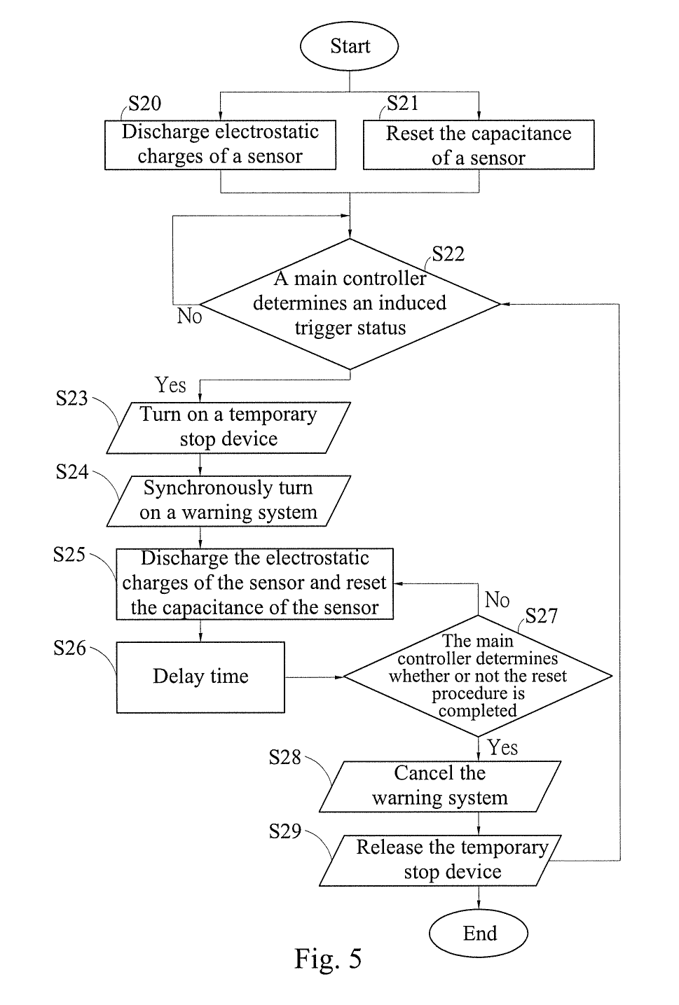

With reference to FIG. 5 for an operating method of a safety device for a machine tool in accordance with the present invention, the following startup and operating procedures assure the protection effect:

(1) Reset the detection unit, discharge the electrostatic charge of the electrostatic charge sensor (S21), set the threshold as a reference value, and reset the capacitance of the capacitance sensor (S20).

(2) The main controller determines an induced trigger status (S22). If no trigger is induced, then the monitor and control will continue. If the trigger is induced, then the following steps will take place.

(3) After the trigger is induced, the temporary stop device is turned on to brake the motor in a reverse direction (S23).

(4) Synchronously turn on the warning system to produce warning sound and light (S24).

(5) Discharge the electrostatic charge of the electrostatic charge sensor, set the threshold as a reference value, and reset the capacitance of the capacitance sensor, after the troubleshooting is completed (S25).

(6) Provide a delay time (S26) between the steps of discharging the electrostatic charge of the electrostatic charge sensor and resetting the capacitance of the capacitance sensor for the main controller to determine whether or not procedure is completed (S27).

(7) The main controller determines whether or not the reset step is completed (S27). If the reset step is not completed, a wait continues. If the reset step is completed, the procedure goes to the next step.

(8) Cancel the warning system to turn off both warning sound and light (S28).

(9) Release the temporary stop device to resume the operation of the motor (S29).

With the aforementioned design, the present invention has the following advantages:

(1) The present invention no longer requires introducing electrostatic charges to a cutting machine (or a saw blade), but simply discharging the electrostatic charge of electrostatic charge sensor to simplify the operation.

(2) The temporary stop device of the present invention provides a braking effect by rotating the motor in a reverse direction, so that there will be no issues on the worn-out of the cutting machine and additional cost incurred.

(3) The capacitance sensor of the present invention is installed in front of the machine to have a greater response time for both of the protection system and the users, so as to minimize the damages and injuries.

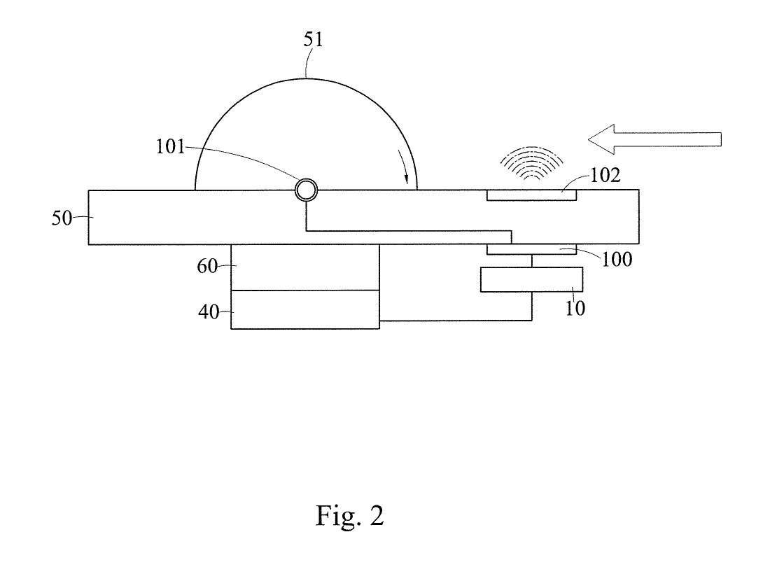

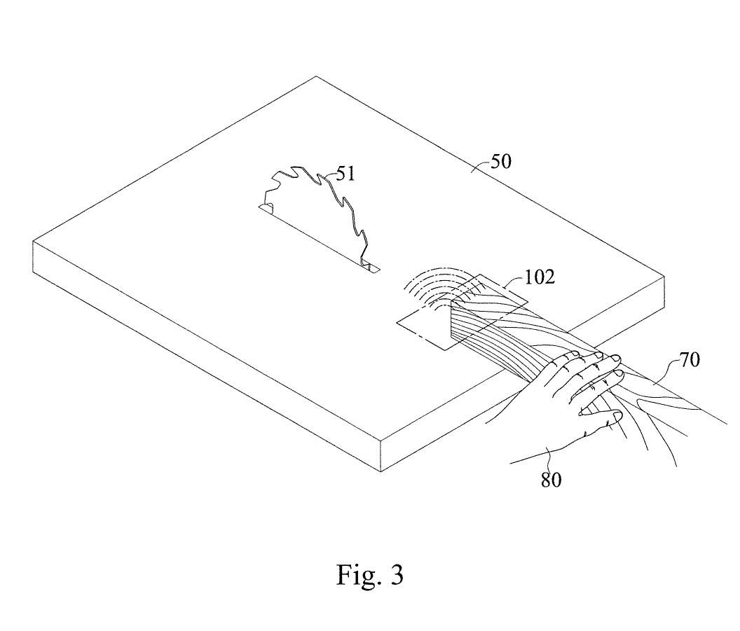

(4) The present invention uses two types of sensors at the same time (as shown in FIGS. 2 and 3) to provide a better safety protection.

While the invention has been described by means of specific embodiments, numerous modifications and variations could be made thereto by those skilled in the art without departing from the scope and spirit of the invention set forth in the claims.

The present invention has the aforementioned advantages of a safe use, a simple operation and a less worn-out of the cutting machine. Obviously, the invention improves over the prior art and complies with the patent application requirements, and thus is duly filed for patent application.

What is claimed is:

1. A safety device for a machine tool, comprising:
a machine, having a saw blade installed thereon and driven by a motor to rotate;
a main controller, for determining an induced trigger status to generate an analog signal;
a detection unit, electrically coupled to the main controller, and comprising:
a contact sensing element, being an electrostatic charge sensor, and using a grounding line and a Darlington trigger method to sense a signal of a charged body, and setting a threshold of the electrostatic charge sensor as a reference value, and creating an induced trigger when an electric charge is different from the reference value; and
a non-contact sensing element, being a capacitance sensor, and forming an induced space magnetic field, and forming an induced trigger when the charged body approaches the induced space magnetic field, and after the detection unit is induced and triggered, a sensing signal is transmitted to and interpreted by the main controller;
a warning system, electrically coupled to the main controller, for turning on the warning system after the analog signal is received;
a drive circuit, electrically coupled to the main controller, for transmitting the analog signal to drive a brake; and
a temporary stop device, electrically coupled to the drive circuit, for rotating the motor in a reverse direction immediately after the analog signal is received.

2. The safety device for a machine tool as recited in claim 1, wherein the warning system includes a warning light and an alarm.

3. The safety device for a machine tool as recited in claim 1, wherein the electrostatic charge sensor is installed at the axis of the saw blade, so that the saw blade becomes a sensing component, and the capacitance sensor is installed at a position in front of the saw blade.

4. An operating method of the safety device for a machine tool as recited in claim 1, comprising the steps of:
resetting the detection unit to discharge electrostatic charges of the electrostatic charge sensor, setting a threshold of the detection unit as a reference value, and resetting the capacitance of the capacitance sensor;
determining an induced trigger status by the main controller;
turning on the temporary stop device to brake the motor in a reverse direction after a trigger is induced;
turning on the warning system to produce warning sound and light simultaneously;
discharging the electrostatic charges of the electrostatic charge sensor, setting the threshold to a reference value, and resetting the capacitance of the capacitance sensor after a troubleshooting is completed;
determining whether or not the resetting process is completed by the main controller;
simultaneously cancelling the warning system to turn off both warning sound and light; and
releasing the temporary stop device to resume the operation of the motor.

5. The operating method of a safety device for a machine tool as recited in claim 4, wherein the steps of discharging the electrostatic charge of a first sensor and resetting the capacitance of the second sensor include a delay time provided for the main controller to determine whether or not the procedure is completed.
